(19) United States
(12) Patent Application Publication
(10) Pub. No.: US 2026/0139652 A1
(43) Pub. Date: May 21, 2026

(54) IGNITION SWITCH

(71) Applicant: HONEYWELL INTERNATIONAL INC., Charlotte, NC (US)

(72) Inventors: Gangaraju, Varturhobli Bangalore KA (IN); Arulselvam ARUMUGAM, Varturhobli Bangalore KA (IN); Vishwanath BALEKUNDRI, Varturhobli Bangalore KA (IN)

(21) Appl. No.: 19/378,928

(22) Filed: Nov. 4, 2025

(30) Foreign Application Priority Data
Nov. 20, 2024 (IN) 202411090134

(51) Int. Cl. F02N 11/08; H01H 1/20; H01H 1/32; H01H 27/06

(52) U.S. Cl. CPC F02N 11/087; H01H 1/205; H01H 1/32; H01H 27/06

(57) ABSTRACT

Apparatuses, systems, and methods are provided for at least ignition switches. An exemplary ignition switch may include a rotor. The exemplary ignition switch may include a contact having one or more protruding portions configured to mechanically couple the contact to the rotor. The exemplary ignition switch may include a spring locator configured to couple at least one spring to the contact via aligning the at least one spring within a cavity defined by the rotor.

### CROSS-REFERENCE TO RELATED APPLICATIONS

This application claims priority pursuant to 35 U.S.C. 119(a) to Indian Application No. 202411090134, filed November 20, 2024, which application is incorporated herein by reference in its entirety.

### FIELD OF THE INVENTION

Embodiments of the present disclosure generally relate to ignition switches and, particularly, to contacts comprised therein.

### BACKGROUND

In some examples, an ignition switch may face various challenges, for example, resulting from configurations of a rotor of the ignition switch. In such examples, the rotor comprises a commutator contact, at least one spring, and a detent. The commutator contact may be configured to compress the at least one spring and rotate corresponding to the rotor to connect with a stationary terminal contact. Offsets produced by such a configuration of the elements may result in: (i) non-uniform rotation(s) and/or spring compression; (ii) misalignment between the rotor and the contact producing at least one air gap; and/or other issues. The at least one air gap may result in a region of low resistance, which may allow for electric arcing and/or increases in temperature that may cause the ignition switch to fail under some conditions. Applicant has identified many technical challenges and difficulties associated with such ignition switches and contacts. Through applied effort, ingenuity, and innovation, many of these identified problems have been solved by developing solutions that are included in embodiments of the present disclosure, many examples of which are described in detail herein.

### BRIEF SUMMARY

Various example embodiments described herein relate to ignition switches and, particularly, to contacts comprised therein.

According to an aspect of the present disclosure, an apparatus is provided, comprising: (i) a rotor; (ii) a contact having one or more protruding portions configured to mechanically couple the contact to the rotor; and (iii) a spring locator configured to couple at least one spring to the contact via aligning the at least one spring within a cavity defined by the rotor.

In some embodiments, the rotor comprises a detent.

In some embodiments, the contact is substantially U-shaped and comprises substantially defined corners, and wherein the one or more protruding portions of the contact are disposed approximately at a center of respective elongated side portions of the contact.

In some embodiments, the contact is substantially U-shaped and comprises substantially defined corners, and wherein the one or more protruding portions of the contact are disposed at one or more side edges of respective elongated side portions of the contact.

In some embodiments, the spring locator protrudes from approximately a center of an elongated middle portion of the contact, and wherein the spring locator is substantially semi-spherical.

In some embodiments, the approximately centered spring locator is configured to symmetrically align the contact, via aligning the at least one spring, to at least the rotor.

In some embodiments, the apparatus is configured to prevent at least one air gap from forming between the contact and at least one portion of the rotor.

According to an aspect of the present disclosure, a system is provided, comprising: (1) an engine; and (2) an ignition switch comprising: (i) a rotor; (ii) a contact having one or more protruding portions configured to mechanically couple the contact to the rotor; and (iii) a spring locator configured to couple at least one spring to the contact via aligning the at least one spring within a cavity defined by the rotor.

In some embodiments, the rotor comprises a detent.

In some embodiments, the contact is substantially U-shaped and comprises substantially defined corners, and wherein the one or more protruding portions of the contact are disposed approximately at a center of respective elongated side portions of the contact.

In some embodiments, the contact is substantially U-shaped and comprises substantially defined corners, and wherein the one or more protruding portions of the contact are disposed at one or more side edges of respective elongated side portions of the contact.

In some embodiments, the spring locator protrudes from approximately a center of an elongated middle portion of the contact, and wherein the spring locator is substantially semi-spherical.

In some embodiments, the approximately centered spring locator is configured to symmetrically align the contact, via aligning the at least one spring, to at least the rotor.

In some embodiments, the ignition switch is configured to prevent at least one air gap from forming between the contact and at least one portion of the rotor.

According to an aspect of the present disclosure, a method is provided, comprising: (i) coupling a contact to a rotor via one or more protruding portions of the contact configured to mechanically couple the contact to the rotor; and (ii) coupling, via a spring locator, at least one spring to the contact via aligning the at least one spring within a cavity defined by the rotor.

In some embodiments, the rotor comprises a detent.

In some embodiments, the method further comprises: (i) configuring the contact such that it is substantially U-shaped; (ii) defining substantially defined corners of the contact; and (iii) defining the one or more protruding portions of the contact at approximately a center of respective elongated side portions of the contact.

In some embodiments, the method further comprises: (i) configuring the contact such that it is substantially U-shaped; (ii) defining substantially defined corners of the contact; and (iii) defining the one or more protruding portions of the contact at one or more side edges of respective elongated side portions of the contact.

In some embodiments, the method further comprises: (i) defining the spring locator such that it protrudes from approximately a center of an elongated middle portion of the contact; and (ii) defining the spring locator such that it is substantially semi-spherical.

In some embodiments, the method further comprises configuring the approximately centered spring locator to symmetrically align the contact, via aligning the at least one spring, to at least the rotor.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is a cross-sectional view of an exemplary ignition switch;

FIG. 2A is a perspective view of the rotor of FIG. 1;

FIG. 2B is a perspective, cross-sectional view of the rotor of FIG. 1;

FIG. 3A is a perspective view of an exemplary contact;

FIG. 3B is a perspective view of an exemplary contact;

FIG. 4A is a perspective, exploded view of at least a portion of an ignition switch;

FIG. 4B is a perspective, exploded view of at least a portion of an ignition switch;

FIG. 5A is a cross-sectional view of the ignition switch of FIG. 4A;

FIG. 5B is a cross-sectional view of the ignition switch of FIG. 4B;

FIG. 6A is a flowchart of an exemplary method of fabricating an example ignition switch; and

FIG. 6B is a flowchart of an exemplary method of fabricating an example ignition switch, in accordance with some embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” “bottom,” “left,” “right,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The phrases “in one example,” “according to one example,” “in some examples,” and the like generally mean that the particular feature, structure, or characteristic following the phrase may be included in at least one example of the present disclosure and may be included in more than one example of the present disclosure (importantly, such phrases do not necessarily refer to the same example).

If the specification states a component or feature “may,” “can,” “could,” “should,” “would,” “preferably,” “possibly,” “typically,” “optionally,” “for example,” “as an example,” “in some examples,” “often,” or “might” (or other such language) be included or have a characteristic, that specific component or feature is not required to be included or to have the characteristic. Such component or feature may be optionally included in some examples, or it may be excluded.

The word “example” or “exemplary” is used herein to mean “serving as an example, instance, or illustration.” Any implementation described herein as “example” or “exemplary” is not necessarily to be construed as preferred or advantageous over other implementations.

The term “electrically coupled,” “electrically coupling,” “electrically couple,” “electrically connected,” “electrically connecting,” “electrically connect,” “in communication with,” or “in electronic communication with” in the present disclosure refers to two or more elements or components being connected through wired means and/or wireless means, such that signals, electrical voltage/current, data and/or information may be transmitted to and/or received from these elements or components.

The term “in fluid communication with” in the present disclosure refers to two or more elements or components being connected through one or more paths or pathways, such that a fluid or other flowing media may be input to and/or output from these elements or components.

The term “component” may refer to an article, a device, or an apparatus that may comprise one or more surfaces, portions, layers and/or elements. For example, an example component may comprise one or more substrates that may provide underlying layer(s) for the component and may comprise one or more elements that may form part of and/or are disposed on top of the substrate.

In the present disclosure, the term “element” may refer to an article, a device, or an apparatus that may provide one or more functionalities.

The term “sensor” refers to a component that may detect, measure, and/or identify any one or more attributes or characteristics of an environment of media.

In some examples, devices disclosed and/or discussed herein may include ignition switches (which may also be referred to as “key switches”). In particular, ignition switches may comprise rotors, contacts, springs, and/or other components.

In some examples, an ignition switch may face various challenges, for example, resulting from configurations of a rotor of the ignition switch. In such examples, the rotor comprises a commutator contact, at least one spring, and a detent. The commutator contact may be configured to compress the at least one spring and rotate corresponding to the rotor to connect with a stationary terminal contact. Offsets produced by such a configuration of the elements may result in: (i) non-uniform rotation(s) and/or spring compression; (ii) misalignment between the rotor and the contact producing at least one air gap; and/or other issues. The at least one air gap may result in a region of low resistance, which may allow for electric arcing and/or increases in temperature that may cause the ignition switch to fail under some conditions.

Embodiments of the present disclosure, in some examples, provide apparatuses, systems, and methods for ignition switches and, particularly, to contacts comprised therein.

In some examples, an ignition switch may comprise a rotor. The rotor may define a plurality of various protruding portions and various cavities configured to function variously. For example, the rotor may define one or more detents. For example, the rotor may define one or more cavities configured to enclose at least one spring.

In some examples, the ignition switch may comprise a contact. The contact may be variously configured. The contact may be comprised of an elongated, substantially rectangular structure configured (e.g., bent at one or more locations) to resemble a U-shape having substantially sharp, defined, and/or angular corners. The contact may comprise one or more protruding portions. The one or more protruding portions may be substantially triangular and/or of other geometries. In a first example, the one or more protruding portions may extend from approximately the centers of respective elongated side portions of the contact. In a second example, the one or more protruding portions may extend from one or more (e.g., two) side edges of respective elongated side portions of the contact. The one or more protruding portions may be configured to mechanically couple the contact to the rotor (e.g., via snapping and/or fitting into one or more of the various cavities defined by the rotor ).

In some examples, the contact may define a spring locator. The spring locator may be a substantially semi-spherical structure extending from approximately the center of an elongated middle portion (which may also be referred to as the “bottom portion”) of the contact. The spring locator may be configured to stabilize (and/or retain the position of) the at least one spring such that the spring locator symmetrically aligns the contact, via aligning the at least one spring, to the rotor.

As described herein, embodiments of the present disclosure, in some examples, provide apparatuses, systems, and/or methods for ignition switches and, particularly, for contacts comprised therein.

To address challenges and limitations associated with ignition switches, various examples of the present disclosure may be provided. For example, various examples of the present disclosure may provide example apparatuses, systems, and/or methods for an ignition switch, particularly for a contact having one or more protruding portions and/or a spring locator.

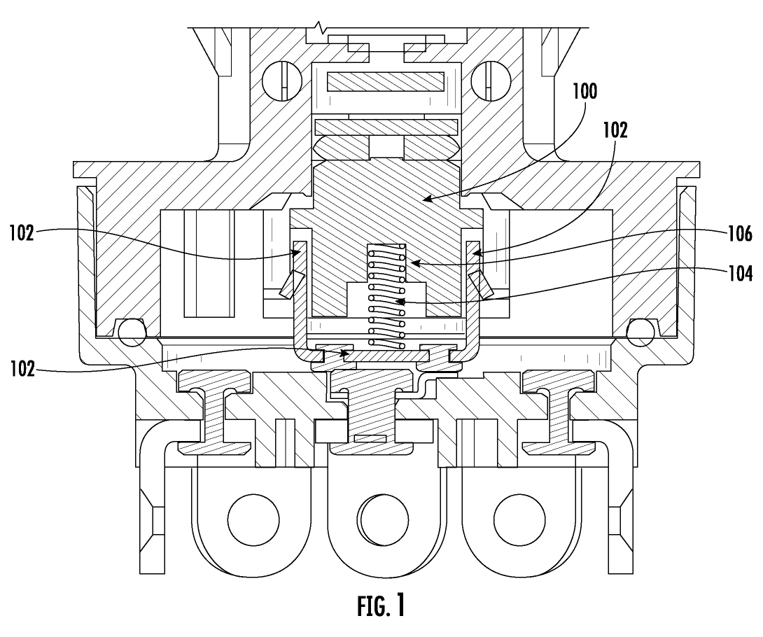

Referring now to FIG. 1, a cross-sectional view of an exemplary ignition switch is provided. The ignition switch may comprise a rotor 100, a contact 102, at least one spring 104, and at least one cavity 106 defined by the rotor 100. Although the exemplary ignition switch of FIG. 1 shows one rotor, one contact, one spring, and one cavity, any number of such components may be present in an ignition switch.

The rotor 100 may be comprised of metal, plastic, and/or other materials. In some examples, the rotor 100 may define one or more various protruding portions. For example, the rotor 100 may define one or more detents. The one or more detents may be configured to mechanically couple the rotor to one or more other components of the ignition switch. In some examples, the rotor 100 may define one or more various cavities. For example, the rotor 100 may define one or more cavities configured to enclose at least one spring. The one or more cavities may be configured to stabilize and/or retain a position of the at least one spring.

The contact 102 may be comprised of metal, plastic, and/or other materials. In some examples, the contact 102 may be variously configured. For example, the contact 102 may be comprised of an elongated, substantially rectangular structure configured (e.g., bent at one or more locations) to resemble a U-shape having substantially sharp, defined, and/or angular corners. The contact 102 may comprise one or more protruding portions. The one or more protruding portions may be substantially triangular, rectangular, and/or of other geometries. In a first example, the one or more protruding portions may extend from approximately the centers of respective elongated side portions of the contact 102 (as shown in FIG. 1). In a second example, the one or more protruding portions may extend from one or more (e.g., two) side edges of respective elongated side portions of the contact 102 (not shown in FIG. 1). The one or more protruding portions may be configured to mechanically couple the contact 102 to the rotor 100 (e.g., via snapping and/or fitting into one or more of the various cavities defined by the rotor ).

The at least one spring 104 may be comprised of metal and/or other materials. The at least one spring 104 may be configured to compress and/or expand during operation of the ignition switch. The contact 102 may further define a spring locator. The spring locator may be a substantially semi-spherical structure extending from approximately the center of an elongated middle portion of the contact 102. The spring locator may be configured to stabilize (and/or retain the position of) the at least one spring 104 such that the spring locator symmetrically aligns the contact 102, via aligning the at least one spring 104, to the rotor 100.

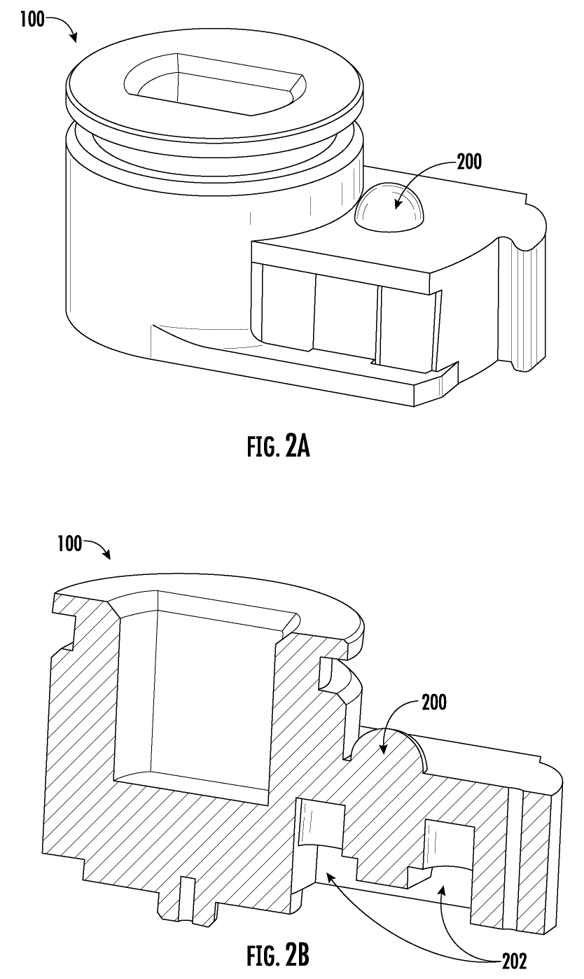

FIGS. 2A-2B show an exemplary rotor, such as the rotor 100. Referring now to FIG. 2A, a perspective view of the rotor of FIG. 1 is provided. In some examples, the rotor 100 may define one or more various protruding portions. For example, the rotor may define one or more protruding portions such as a detent 200. In some examples, the detent 200 may be substantially semi-spherical and/or of other shapes. The detent 200 may be configured to mechanically couple the rotor to one or more other components of the ignition switch (e.g., via snapping and/or fitting into one or more cavities and/or recessed portions defined by the ignition switch ). Referring now to FIG. 2B a perspective, cross-sectional view of the rotor of FIG. 1 is provided. In some examples, the rotor 100 may define one or more various cavities. For example, the rotor 100 may define one or more cavities 202 configured to enclose at least one spring. The one or more cavities 202 may be configured to stabilize and/or retain a position of the at least one spring.

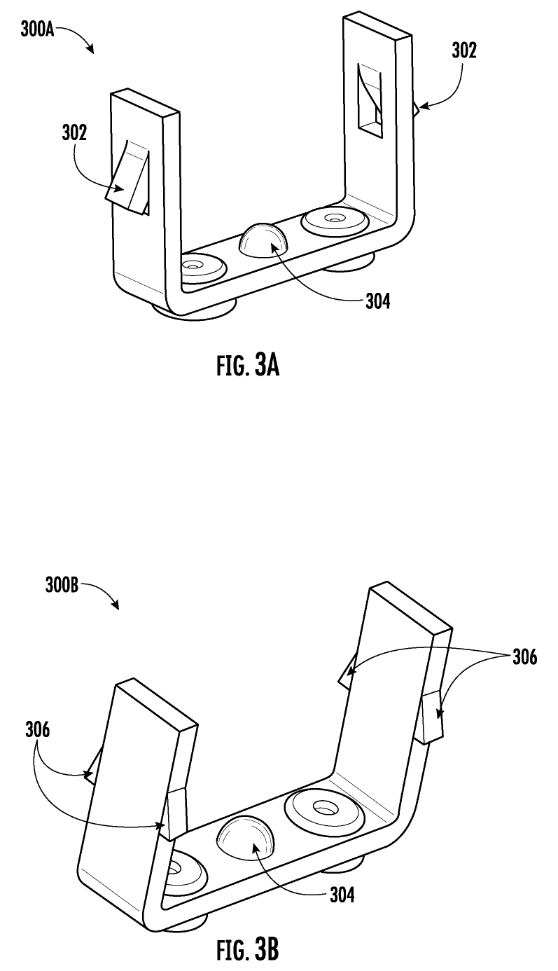

FIGS. 3A-3B show exemplary contacts. Referring now to FIG. 3A, a perspective view of an exemplary contact 300A is provided. The contact 300A may be comprised of metal, plastic, and/or other materials. In some examples, the contact 300A may be comprised of an elongated, substantially rectangular structure configured (e.g., bent at one or more locations) to resemble a U-shape having substantially sharp, defined, and/or angular corners. The contact 300A may comprise one or more protruding portions 302. The one or more protruding portions 302 may be substantially rectangular and/or of other geometries. In some examples, the one or more protruding portions 302 may extend from approximately the centers of respective elongated side portions of the contact 300A. The one or more protruding portions 302 may be configured to mechanically couple the contact 300A to a rotor (e.g., via snapping and/or fitting into one or more of the various cavities defined by the rotor ). The contact 300A may further define a spring locator 304. The spring locator 304 may be a substantially semi-spherical structure extending from approximately the center of an elongated middle portion of the contact 300A. The spring locator 304 may be configured to stabilize (and/or retain the position of) at least one spring such that the spring locator 304 symmetrically aligns the contact 300A, via aligning the at least one spring, to the rotor. Although the contact of FIG. 3A shows one contact, two protruding portions, and one spring locator, any number of such components may be present in a contact.

Referring now to FIG. 3B, a perspective view of an exemplary contact 300B is provided. The contact 300B may be comprised of metal, plastic, and/or other materials. In some examples, the contact 300B may be comprised of an elongated, substantially rectangular structure configured (e.g., bent at one or more locations) to resemble a U-shape having substantially sharp, defined, and/or angular corners. The contact 300B may comprise one or more protruding portions 306. The one or more protruding portions 306 may be substantially triangular and/or of other geometries. In some examples, the one or more protruding portions 306 may extend from one or more (e.g., two) side edges of respective elongated side portions of the contact 300B. The one or more protruding portions 306 may be configured to mechanically couple the contact 300B to a rotor (e.g., via snapping and/or fitting into one or more of the various cavities defined by the rotor ). The contact 300A may further define a spring locator 304. The spring locator 304 may be a substantially semi-spherical structure extending from approximately the center of an elongated middle portion of the contact 300A. The spring locator 304 may be configured to stabilize (and/or retain the position of) at least one spring such that the spring locator 304 symmetrically aligns the contact 300A, via aligning the at least one spring, to the rotor. Although the contact of FIG. 3B shows one contact, four protruding portions, and one spring locator, any number of such components may be present in a contact.

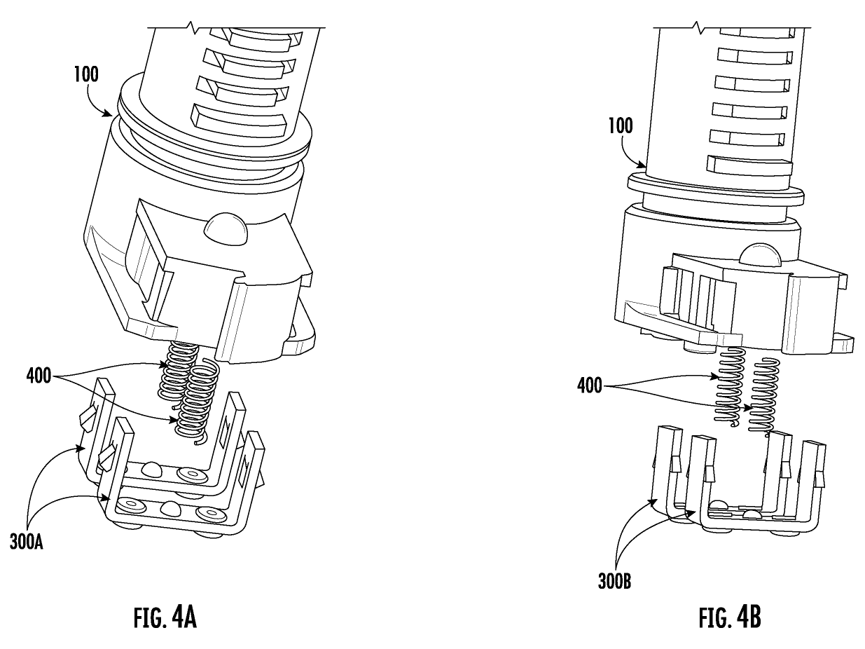

FIGS. 4A-4B show exemplary ignition switches. Referring now to FIG. 4A, a perspective, exploded view of at least a portion of an ignition switch is provided. The example of FIG. 4A includes the rotor 100, at least one contact 300A, and one or more springs 400 (e.g., the at least one spring 104). Although the example of FIG. 4A shows one rotor, two contacts, and two springs, any number of such components may be present in an ignition switch. The rotor 100 may be comprised of metal, plastic, and/or other materials. In some examples, the rotor 100 may define one or more various protruding portions. For example, the rotor 100 may define one or more detents (e.g., such as the detent 200). The one or more detents may be configured to mechanically couple the rotor to one or more other components of the ignition switch. In some examples, the rotor 100 may define one or more various cavities. For example, the rotor 100 may define one or more cavities (e.g., such as the one or more cavities 202) configured to enclose the one or more springs 400. The one or more cavities may be configured to stabilize and/or retain one or more positions of the one or more springs 400. The one or more springs 400 may be comprised of metal and/or other materials. The one or more springs 400 may be configured to compress and/or expand during operation of the ignition switch. A spring locator of the contact 300A may be configured to stabilize (and/or retain the position of) the one or more springs 400 such that the spring locator symmetrically aligns the contact 300A, via aligning the one or more springs 400, to the rotor 100.

Referring now to FIG. 4B, a perspective, exploded view of at least a portion of an ignition switch is provided. The example of FIG. 4B includes the rotor 100, at least one contact 300B, and the one or more springs 400 (e.g., the at least one spring 104). Although the example of FIG. 4B shows one rotor, two contacts, and two springs, any number of such components may be present in an ignition switch. The rotor 100 may be comprised of metal, plastic, and/or other materials. In some examples, the rotor 100 may define one or more various protruding portions. For example, the rotor 100 may define one or more detents (e.g., such as the detent 200). The one or more detents may be configured to mechanically couple the rotor to one or more other components of the ignition switch. In some examples, the rotor 100 may define one or more various cavities. For example, the rotor 100 may define one or more cavities (e.g., such as the one or more cavities 202) configured to enclose the one or more springs 400. The one or more cavities may be configured to stabilize and/or retain one or more positions of the one or more springs 400. The one or more springs 400 may be comprised of metal and/or other materials. The one or more springs 400 may be configured to compress and/or expand during operation of the ignition switch. A spring locator of the contact 300B may be configured to stabilize (and/or retain the position of) the one or more springs 400 such that the spring locator symmetrically aligns the contact 300B, via aligning the one or more springs 400, to the rotor 100.

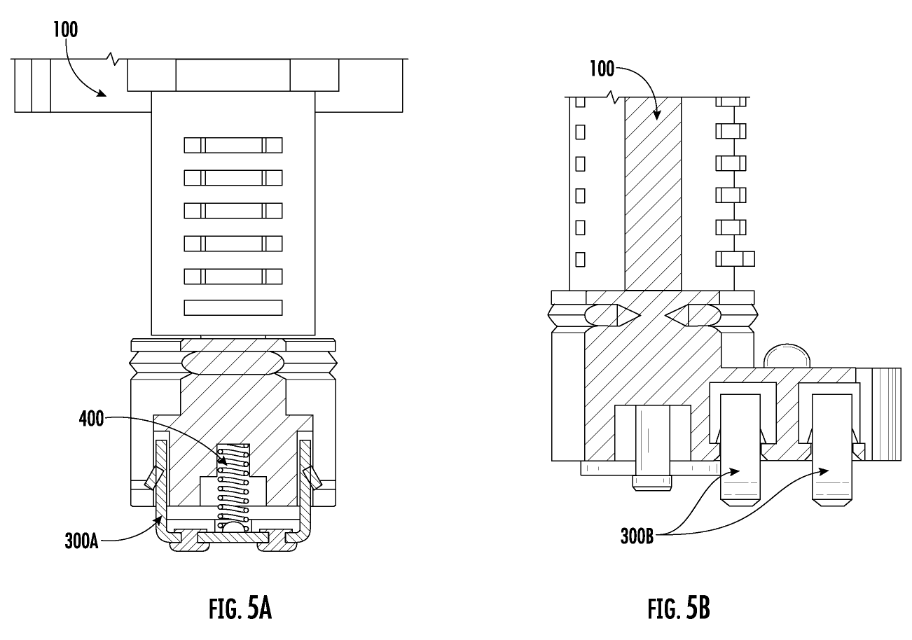

FIGS. 5A-5B show exemplary ignition switches. Referring now to FIG. 5A, a cross-sectional view of the ignition switch of FIG. 4A is provided. The cross-sectional view shows a coupling between the contact 300A and the rotor 100 via the one or more protruding portions 302 (e.g., the substantially centered protruding portions), wherein the one or more protruding portions 302 are configured to snap and/or fit into one or more of the various cavities defined by the rotor. Referring now to FIG. 5B, a cross-sectional view of the ignition switch of FIG. 4B is provided. The cross-sectional view shows a coupling between the contact 300B and the rotor 100 via the one or more protruding portions 306 (e.g., the side/edge protruding portions), wherein the one or more protruding portions 306 are configured to snap and/or fit into one or more of the various cavities defined by the rotor.

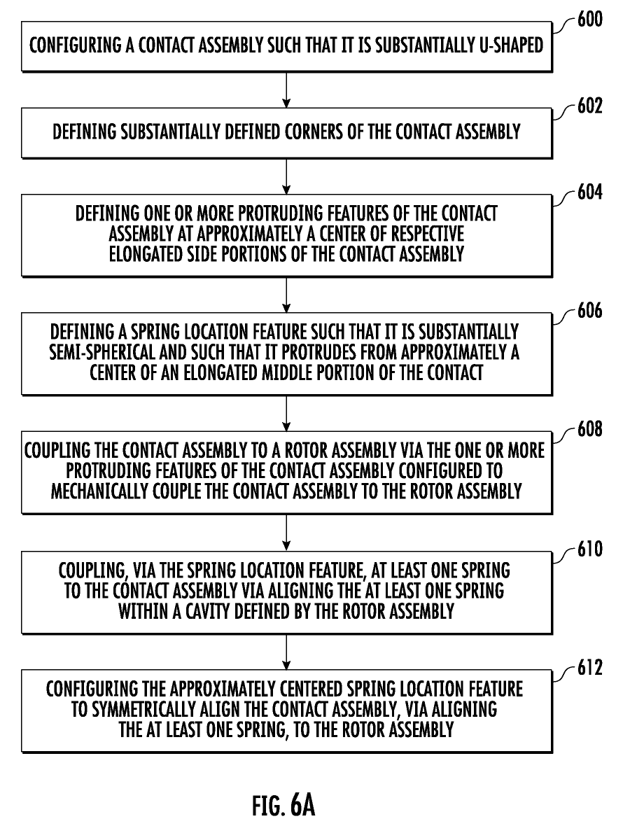

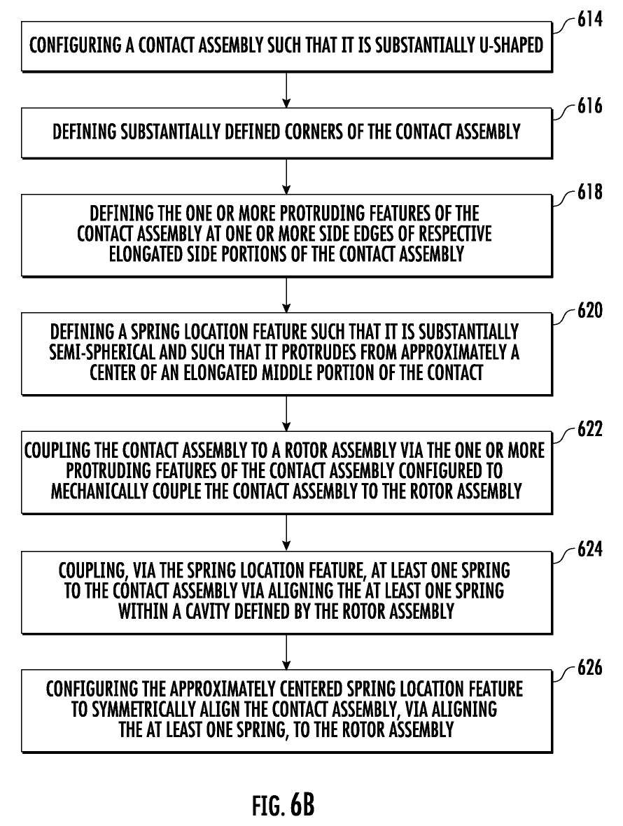

FIGS. 6A-6B show exemplary methods. Referring now to FIG. 6A, a flowchart of an exemplary method of fabricating an example ignition switch is provided. At step/operation 600, a contact (e.g., the contact 300A) may be configured such that it is substantially U-shaped. At step/operation 602, one or more substantially sharp, defined, and/or angular corners of the contact may be defined. At step/operation 604, one or more protruding portions (e.g., the one or more protruding portions 302) of the contact may be defined at approximately a center of one or more respective elongated side portions of the contact. At step/operation 606, a spring locator (e.g., the spring locator 304) may be defined such that it is substantially semi-spherical and such that it protrudes from approximately a center of an elongated middle portion of the contact. At step/operation 608, the contact may be coupled to a rotor (e.g., the rotor 100) via the one or more protruding portions of the contact configured to mechanically couple the contact to the rotor. At step/operation 610, at least one spring (e.g., the at least one spring 104 and/or the one or more springs 400) may be coupled, via the spring locator, to the contact via aligning the at least one spring with a cavity defined by the rotor. At step/operation 612, the approximately centered spring locator may be configured to symmetrically align the contact, via aligning the at least one spring, to the rotor.

Referring now to FIG. 6B, a flowchart of an exemplary method of fabricating an example ignition switch is provided. At step/operation 614, a contact (e.g., the contact 300B) may be configured such that it is substantially U-shaped. At step/operation 616, one or more substantially sharp, defined, and/or angular corners of the contact may be defined. At step/operation 618, one or more protruding portions (e.g., the one or more protruding portions 306) of the contact may be defined at one or more side edges of one or more respective elongated side portions of the contact. At step/operation 620, a spring locator (e.g., the spring locator 304) may be defined such that it is substantially semi-spherical and such that it protrudes from approximately a center of an elongated middle portion of the contact. At step/operation 622, the contact may be coupled to a rotor (e.g., the rotor 100) via the one or more protruding portions of the contact configured to mechanically couple the contact to the rotor. At step/operation 624, at least one spring (e.g., the at least one spring 104 and/or the one or more springs 400) may be coupled, via the spring locator, to the contact via aligning the at least one spring with a cavity defined by the rotor. At step/operation 626, the approximately centered spring locator may be configured to symmetrically align the contact, via aligning the at least one spring, to the rotor.

Operations and processes described herein support combinations of means for performing the specified functions and combinations of operations for performing the specified functions. It will be understood that one or more operations, and combinations of operations, may be implemented by special purpose hardware-based computer systems which perform the specified functions, or combinations of special purpose hardware and computer instructions.

In some example embodiments, certain ones of the operations herein may be modified or further amplified as described below. Moreover, in some embodiments additional optional operations may also be included. It should be appreciated that each of the modifications, optional additions or amplifications described herein may be included with the operations herein either alone or in combination with any others among the features described herein.

The foregoing method and process descriptions are provided merely as illustrative examples and are not intended to require or imply that the steps of the various embodiments must be performed in the order presented. As will be appreciated by one of skill in the art the order of steps in the foregoing embodiments may be performed in any order. Words such as "thereafter," "then," "next," and similar words are not intended to limit the order of the steps; these words are simply used to guide the reader through the description of the methods. Further, any reference to claim elements in the singular, for example, using the articles "a," "an" or "the," is not to be construed as limiting the element to the singular and may, in some instances, be construed in the plural.

While various embodiments in accordance with the principles disclosed herein have been shown and described /above, modifications thereof may be made by one skilled in the art without departing from the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present disclosure. Furthermore, any advantages and features described above may relate to specific embodiments but shall not limit the application of such issued claims to processes and structures accomplishing any or all of the above advantages or having any or all of the above features.

In addition, the section headings used herein are provided for consistency with the suggestions under 37 C.F.R. § 1.77 or to otherwise provide organizational cues. These headings shall not limit or characterize the disclosure set out in any claims that may issue from this disclosure. For instance, a description of a technology in the "Background" is not to be construed as an admission that certain technology is prior art to any disclosure in this disclosure. Neither is the "Summary" to be considered as a limiting characterization of the disclosure set forth in issued claims. Furthermore, any reference in this disclosure to "disclosure" or "embodiment" in the singular should not be used to argue that there is only a single point of novelty in this disclosure. Multiple embodiments of the present disclosure may be set forth according to the limitations of the multiple claims issuing from this disclosure, and such claims accordingly define the disclosure, and their equivalents, which are protected thereby. In all instances, the scope of the claims shall be considered on their own merits in light of this disclosure but should not be constrained by the headings set forth herein.

Also, systems, subsystems, apparatuses, techniques, and methods described and illustrated in the various embodiments as discrete or separate may be combined or integrated with other systems, modules, techniques, or methods without departing from the scope of the present disclosure. Other devices or components shown or discussed as coupled to, or in communication with, each other may be indirectly coupled through some intermediate device or component, whether electrically, mechanically, or otherwise. Other examples of changes, substitutions, and alterations are ascertainable by one skilled in the art and could be made without departing from the scope disclosed herein.

Many modifications and other embodiments of the disclosure set forth herein will come to mind to one skilled in the art to which these embodiments pertain having the benefit of teachings presented in the foregoing descriptions and the associated figures. Although the figures only show certain components of the apparatuses and systems described herein, various other components may be used in conjunction with the components and structures disclosed herein. Therefore, it is to be understood that the disclosure is not to be limited to the specific embodiments disclosed and that modifications and other embodiments are intended to be included within the scope of the appended claims. For example, the various elements or components may be combined, rearranged, or integrated in another system or certain features may be omitted or not implemented. Moreover, the steps in any method described above may not necessarily occur in the order depicted in the accompanying drawings, and in some cases one or more of the steps depicted may occur substantially simultaneously, or additional steps may be involved. Although specific terms are employed herein, they are used in a generic and descriptive sense only and not for purposes of limitation.

What is claimed is:

1. An apparatus comprising:
a rotor;
a contact having one or more protruding portions configured to mechanically couple the contact to the rotor; and
a spring locator configured to couple at least one spring to the contact via aligning the at least one spring within a cavity defined by the rotor.

2. The apparatus of claim 1, wherein the rotor comprises a detent.

3. The apparatus of claim 1, wherein the contact is substantially U-shaped and comprises substantially defined corners, and wherein the one or more protruding portions of the contact are disposed approximately at a center of respective elongated side portions of the contact.

4. The apparatus of claim 1, wherein the contact is substantially U-shaped and comprises substantially defined corners, and wherein the one or more protruding portions of the contact are disposed at one or more side edges of respective elongated side portions of the contact.

5. The apparatus of claim 1, wherein the spring locator protrudes from approximately a center of an elongated middle portion of the contact, and wherein the spring locator is substantially semi-spherical.

6. The apparatus of claim 5, wherein the approximately centered spring locator is configured to symmetrically align the contact, via aligning the at least one spring, to at least the rotor.

7. The apparatus of claim 1, wherein the apparatus is configured to prevent at least one air gap from forming between the contact and at least one portion of the rotor.

8. A system comprising:
an engine; and
an ignition switch comprising:
a rotor;
a contact having one or more protruding portions configured to mechanically couple the contact to the rotor; and
a spring locator configured to couple at least one spring to the contact via aligning the at least one spring within a cavity defined by the rotor.

9. The system of claim 8, wherein the rotor comprises a detent.

10. The system of claim 8, wherein the contact is substantially U-shaped and comprises substantially defined corners, and wherein the one or more protruding portions of the contact are disposed approximately at a center of respective elongated side portions of the contact.

11. The system of claim 8, wherein the contact is substantially U-shaped and comprises substantially defined corners, and wherein the one or more protruding portions of the contact are disposed at one or more side edges of respective elongated side portions of the contact.

12. The system of claim 8, wherein the spring locator protrudes from approximately a center of an elongated middle portion of the contact, and wherein the spring locator is substantially semi-spherical.

13. The system of claim 12, wherein the approximately centered spring locator is configured to symmetrically align the contact, via aligning the at least one spring, to at least the rotor.

14. The system of claim 8, wherein the ignition switch is configured to prevent at least one air gap from forming between the contact and at least one portion of the rotor.

15. A method comprising:
coupling a contact to a rotor via one or more protruding portions of the contact configured to mechanically couple the contact to the rotor; and
coupling, via a spring locator, at least one spring to the contact via aligning the at least one spring within a cavity defined by the rotor.

16. The method of claim 15, wherein the rotor comprises a detent.

17. The method of claim 15, further comprising:
configuring the contact such that it is substantially U-shaped;
defining substantially defined corners of the contact; and
defining the one or more protruding portions of the contact at approximately a center of respective elongated side portions of the contact.

18. The method of claim 15, further comprising:
configuring the contact such that it is substantially U-shaped;
defining substantially defined corners of the contact; and
defining the one or more protruding portions of the contact at one or more side edges of respective elongated side portions of the contact.

19. The method of claim 15, further comprising:
defining the spring locator such that it protrudes from approximately a center of an elongated middle portion of the contact; and
defining the spring locator such that it is substantially semi-spherical.

20. The method of claim 19, further comprising:
configuring the approximately centered spring locator to symmetrically align the contact, via aligning the at least one spring, to at least the rotor.
